(19) United States
(12) Patent Application Publication
(10) Pub. No.: US 2026/0108842 A1
(43) Pub. Date: Apr. 23, 2026

(54) A METHOD AND A SYSTEM FOR SEPARATING CO2 FROM THE ADDITIONAL CONSTITUENTS OF A GAS MIXTURE COMPRISING AT LEAST 70% AND UP TO 90% CO2

(71) Applicant: CARBFIX HF, Reykjavik (IS)

(72) Inventors: Nökkvi ANDERSEN, Reykjavik (IS); Magnús Þór ARNARSON, Reykjavik (IS); Kári HELGASON, Reykjavik (IS); Thomas RATOUIS, Reykjavik (IS); Bergur SIGFÚSSON, Reykjavik (IS); Sandra Ósk SNÆBJÖRNSDÓTTIR, Reykjavik (IS); Martin Johannes VOIGT, Reykjavik (IS)

(73) Assignee: CARBFIX OHF, Reykjavik (IS)

(21) Appl. No.: 18/873,643

(22) PCT Filed: Jun. 12, 2023
(86) PCT No.: PCT/EP2023/065608

§ 371 Date: Dec. 10, 2024

(30) Foreign Application Priority Data
Jun. 10, 2022 (EP) 22178359.0

(51) Int. Cl. B01D 53/14

(52) U.S. Cl. CPC B01D 53/1475; B01D 53/1418; B01D 53/1431; B01D 2252/1035; B01D 2257/504

(57) ABSTRACT

This invention relates to a method and a system for separating carbon dioxide (CO₂) from a CO₂ containing gas mixture comprising at least 70% and up to 90% CO₂ by volume such as gas stream from Direct Air Capture systems. The CO₂ gas is separated from the remaining gases contained in the CO₂ containing gas mixtures by pressurizing the gas stream and feeding it into an absorption column where CO₂ is brought into contact with and preferentially dissolved in a water stream, resulting in water stream enriched in CO₂. The CO₂ containing water stream may then be re-injected into a geological reservoir or sent to a system where the CO₂ is exsolved from the water by releasing the pressure thus producing a stream of CO₂ suitable for utilization. The stream of water may then reused in the absorption column.

### FIELD OF THE INVENTION

The present invention relates to a method and a system for separating substantially all of the carbon dioxide (CO2) from the additional constituents of gas-mixtures comprising at least 70% and up to 90% CO2 by volume. The gas mixtures preferably originate e.g. from systems for so-called Direct Air Capture (DAC) of CO2 or units designed to capture and/or concentrate CO2 containing gas mixtures emitted from e.g. industrial plants or power plants. To the extent that the CO2 containing gas mixtures originate from systems for Direct Air Capture (DAC) of CO2 it will preferably comprise at least 80% and up to 90% CO2 by volume and can have water contents above 500 ppm and/or a relative humidity of from 20 to 100% (i.e. it can be saturated with H2O at the given temperature and pressure).

The method and systems of the present invention are characterized in that they rely on contacting a stream of a first gas mixture (G1) comprising at least 70% and up to 90% CO2 by volume with a first stream of water (W2), thereby producing a second stream of water (W4), which has been enriched with dissolved CO2 compared to said first stream of water (W2) and a pressurized gas mixture (G3), which has been depleted of substantially all of the CO2 compared to said first gas mixture (G1). Preferably the first gas mixture (G1) will comprise at least 80% and up to 90% CO2 by volume and can have water contents above 500 ppm and/or a relative humidity of from 20 to 100% (i.e. it can be saturated with H2O at the given temperature and pressure).

In one embodiment of the present invention the water stream (W4) produced may, e,g, if said first water stream (W2) is in the form of groundwater from a geological reservoir, be transferred to an injection system for injecting into said geological reservoir and subsequently storing CO2 contained therein in said geological reservoir.

Alternatively, in another embodiment of the present invention the water stream (W4) produced may, if said gas mixture (G1) comprises less than 10%, such as less than 8, less than 6 or less than 4%, by volume of any gas or gases, which at the pressures and temperatures applied has or have a solubility in water, which is either equal to or higher than that of carbon dioxide (CO2), or which at a pressure of 1 atm and at temperatures between 1° and 70° C. has a solubility in water of from 0.5 to 2.5 g per kg of water, be transferred to a system for desorbing or desorption of the CO2 dissolved in said water stream (W4) thereby generating a stream of concentrated and purified CO2, and a third stream of water (W5), which third stream of water (W5) may be recirculated to the flow of said first water stream (W2) at a point, which is prior to said first water stream (W2) being contacted with said gas mixture (G1).

Further alternatively, in yet another embodiment of the present invention, in which said first water stream (W2) is in the form of sea water, the water stream (W4) may be collected and stored for subsequent use, e,g, for transport of the captured CO2 for utilization or for transfer of the captured CO2 to permanent or intermediate storage.

The gas-mixtures, from which substantially all of the carbon dioxide (CO2) can be separated from the additional constituents in the methods and systems of the present invention, may originate from any source. However, gas mixtures originating from e.g. systems for Direct Air Capture (DAC) or units designed to capture or concentrate the CO2 in CO2 containing gas mixtures emitted from e.g. industrial plants or power plants are particularly well-suited for methods and systems according to the present invention. CO2 containing gas mixtures captured by DAC systems commonly contain significant amounts of other gases originating from the atmosphere, such as nitrogen (N2), oxygen (O2), and Argon (Ar) that need to be separated from the captured CO2, if the CO2 is to be utilized or stored for subsequent use.

Most processes for further purification of CO2 containing gas streams obtained by DAC today rely on subsequent liquefaction and transport of the CO2 by compression at elevated pressures and low temperatures, which with the currently available technologies is a relatively energy demanding process. Furthermore, gas streams obtained by DAC generally, and in particular when based on regular atmospheric air, normally will contain relatively high amounts of moisture, which with the currently available technologies tend to be problematic in scenarios involving further processing to more concentrated CO2 streams, by e.g. CO2 liquefaction. Thus, compressing CO2 with significant amounts of water present produces a fluid that causes significant corrosion of pipeline and well materials. Although most of the water in a typical gas mixture obtained by DAC can be separated from the CO2 by cooling and condensation, there will normally be a need for additional drying to bring water content from about 2-4% to below 500 ppm.

In contrast, the methods and systems of the present invention, rely on pressurized water scrubbing to separate substantially all of the CO2 from the additional constituents of gas-mixtures (G1) comprising at least 70% and up to 90% CO2 by volume, such as the additional gases which are part of the gas mixtures normally obtained from a DAC system. Hence, unlike the processes for further purification of CO2 containing gas streams obtained by DAC known today, the methods and systems of the present invention avoid the need for additional drying to bring the water content from 2-4% to below 500 ppm. Thus, to the extent that the gas mixtures originate from Direct Air Capture (DAC) systems the first gas mixture (G1) will preferably comprise at least 80% and up to 90% CO2 by volume and can have a relative humidity of up from 20 to 100% (i.e. it can be saturated with H2O at the given temperature and pressure), and the handling of gas-mixtures (G1) with water contents above 500 ppm is unproblematic. The CO2 charged water (W4), which is thereby obtained, can then e.g. be diverted to an injection well for permanent removal from the atmosphere through solubility trapping and subsequent mineral trapping by aqueous chemical reactions resulting in permanent sequestration through mineral storage.

Alternatively, the water stream (W4) enriched with dissolved CO2 may be transferred to a system for desorbing the CO2 dissolved in said second water stream (W4), e.g. by lowering the pressure, thus desorbing at least part of the CO2 dissolved in the water to generate a concentrated and purified CO2 stream, which can be used for other purposes e.g. production of fuels or surface carbonation.

As a further alternative, the CO2 charged water stream (W4) may, if the first water stream (W2) is based on sea water, be collected and stored for subsequent use, e.g. for transport of the captured CO2 for utilization or for transfer of the captured CO2 to permanent or intermediate storage.

To optimize the use of water resources, the source of water in methods and systems according to the present invention can, in case the CO2 containing gas stream (G1) is obtained by DAC, be condensate from air originating from a DAC system.

For geological storage, the methods and systems according to the present invention can rely on contacting said gas mixtures (G1) with a water stream (W2), which is in the form of groundwater from a geological reservoir, and then transferring the produced water stream (W4), enriched with dissolved CO2, to an injection system for injecting said second water stream (W4) into the same geological reservoir for mineral storage of CO2.

In case the CO2 containing gas stream (G1) is obtained by DAC, any water, to be used as the first water stream (W2) in the methods and systems of the present invention, may be used in the DAC system, e.g. as a source of energy, prior to being diverted to the methods and systems of the present invention.

The methods and systems according to the present invention in general decrease the overall electricity demand of a process for separation of CO2 from CO2 containing gas mixtures compared to methods and systems relying on the removal of water by drying (or cooling and condensation) and subsequent liquefaction of the CO2 by compression. The methods and systems of the present invention are relevant in relation to all applications that require either water-dissolved CO2 or purified gaseous CO2, and mitigates the steps of drying, liquefaction and CO2 vaporization/re-gasification otherwise characteristic of known processes for handling CO2 containing gas mixtures stemming from e.g. DAC systems. This simplification, relative to the known processes for separation of CO2 from CO2 containing gas mixtures, leads to both a decrease in relation to equipment requirements and in general decreases the energy consumption, which in turn lowers both the necessary capital costs and operating expenses of methods and systems according to the present invention compared to those of the prior art.

### BACKGROUND OF THE INVENTION

CO2 is a gas that has historically been released in large quantities in relation to a wide range of industrial processes, e.g. combustion of fossil fuels, production of cement, aluminum and steel. Being a greenhouse gas, CO2 in the atmosphere is the key driver of climate change.

Reaching net-zero CO2 emissions is essential to mitigate climate change. In addition to significant emission reduction, the deployment of CO2 removal technologies is also needed to address hard-to-abate emissions such as emissions from aviation, and to remove CO2 that has already been emitted. Net negative-emission pathways are needed by the latter half of the 21st century to limit global warming to 1.5° C. or below.

Direct air capture (DAC) technologies extract CO2 directly from the atmosphere. The separated CO2 can then be safely and permanently stored deep underground or converted into products through utilization processes.

The most established forms of DAC primarily rely on two different approaches to capture CO2 from the air: liquid and solid DAC.

On one hand, Liquid DAC systems pass air through chemical solutions (e.g. a hydroxide solution), which removes the CO2.

Solid DAC technology on the other hand makes use of solid sorbent filters that chemically bind with CO2.

Regardless of the specific technology used, capturing CO2 from the atmosphere, for subsequent storage or use, through direct air capture is currently expensive. The CO2 concentration in the atmosphere is much more diluted than in, for example, flue gas from a power station or a cement plant. This results in relatively high energy need relative to other CO2 capture technologies and applications. The specific costs and energy needs vary according to the type of technology used. In most current scenarios, however, the CO2 captured (whether by solid or liquid DAC) needs to be both released from the material in which it has been captured and, as none of the currently known DAC technologies result in 100% pure CO2, the resulting gas mixture needs to be subsequently further purified by both the removal of water and compression under high pressure. These steps increase both capital costs (due to the requirement for additional equipment such as a compressor) and operating expenses (to run the compressor) of most current DAC plants.

In the Net Zero Emissions by 2050 Scenario contemplated as part of the Paris agreement, DAC would have to be scaled up to capture more than 85 Mt CO2/year by 2030 and ˜980 Mt CO2/year by 2050. This level of deployment will require several more largescale demonstrations to refine the technology and reduce capture costs. Consequently, DAC is a growing field of technology and is considered necessary to be able to manage climate change. As mentioned above, however, the primary limitation of large-scale implementation of DAC technologies at their current state of development is the system's energy demand: DAC technologies are very energy intensive and dependent on carbon neutral energy resources. Hence, strategies that minimize energy consumption are a vital step for the scale up of DAC technologies to the required Gt-scale.

A substantive part of the energy requirements of most known DAC systems are steps taken to prepare the CO2 enriched gas stream resulting from the initial DAC step for geological storage, or utilization after the capturing process, e.g. in the form of the energy required for liquefaction by compression.

Even if DAC technologies are becoming quite diverse, most of the earliest and more established ones are, as mentioned above, based on adsorption/desorption processes. In these processes, CO2 adsorption is performed without pre-treating the incoming air stream, and CO2 desorption is performed through a temperature-vacuum-swing (TVS) process. During this process the pressure in the system is reduced and the temperature is increased, thereby releasing the captured CO2. After a cooling phase, the whole process is repeated. The resulting gas stream of such processes is unavoidably of variable chemical composition and the exact concentration of CO2 in the resulting CO2/air gas mixture depends on the operational parameters of the system. In most cases, however, the resulting gas mixture will, even if enriched with CO2, have to be subjected to additional processing steps prior to e.g. injection for geological storage, or utilization.

One way of separating the CO2 from the other gases in a gas mixture exiting a DAC system is by means of liquefaction. In such processes, the gas mixture is cooled and compressed and any N2, 02 and Ar, which have lower boiling points than CO2, are vented from the system resulting in the production of pure liquid CO2 which may be either transferred to geological storage or supplied to utilization processes. The energy demand to form liquid CO2 by pressurizing pure CO2 gas to its liquefaction pressure is high. For gas mixtures comprising also other gases than CO2 the energy demand would be even higher. If the final desired product of a given process is gaseous CO2 additional energy in the form of heat would be required to convert liquid CO2 to its gaseous counterpart. One application of this is when the CO2 captured by a DAC process is to be dissolved in water and injected into the subsurface for instant solubility trapping and subsequent mineral storage. In addition, the gas mixtures from the DAC typically contain air and moisture that must be separated from the CO2 prior to compression and subsequent storage/utilization. Hence, the overall energy consumption of CO2 post-capture processing, and, thus, the overall energy consumption per ton of CO2 actually captured for e.g. geological storage, could be significantly decreased if the purification and compression steps of traditional DAC processes could be avoided.

In addition to the above-mentioned traditional DAC processes, it has also been suggested to capture carbon dioxide capture from atmospheric air for subsequent geological storage through multiple stages of aeration (dissolving of the gas into water) followed by deaeration (stripping of the gas from the water) until a high concentration of carbon dioxide remains that is of sufficient quality for sequestration. However, as these methods rely on the ability to process both the relevant gas mixtures and the water at very low temperatures, i.e. in order to be effective they are to be practiced at temperatures where the water is as cold as possible, they too suffer from a relatively high overall energy consumption per ton of CO2 actually captured for possible geological storage.

The methods and systems of the present invention provide a solution to this problem by avoiding the purification and compression steps of traditional DAC processes and by avoiding any need for the cooling of the relevant gas mixtures and water. This is achieved by absorption of substantially all of the relatively soluble CO2 gas, from the relatively impure gas mixtures, which are normally obtained in traditional DAC processes, into a stream of water under moderately increased pressure at near ambient temperatures, i.e. at temperatures between app. 10 and app 50° C. Thus, the inventors of the present invention have for the first time described a system and a method that meets the need for a less energy consuming, and construction- and operation-wise simpler, method for separating substantially all of the CO2 from a first gas mixture (G1) derived e.g. from traditional DAC systems, which relies on contacting the gas mixture (G1) with a first stream of water (W2), thereby producing a second stream of water (W4), which has been enriched with dissolved CO2 compared to said first stream of water (W2) and a stream of pressurized gas (G3), which has been depleted of substantially all of the CO2 compared to said flow of said first gas mixture (G1).

The water stream (W4) produced may, e.g. if said first water stream (W2) is in the form of groundwater from a geological reservoir, be transferred to an injection system for injecting into said geological reservoir and subsequently storing CO2 contained therein in said geological reservoir.

Alternatively, the water stream (W4) produced may, if said gas mixture (G1) comprises less than 10%, such as less than 8, 6 or 4%, by volume of any gas or gases, which at the pressures and temperatures applied has or have a solubility in water, which is either equal to or higher than that of carbon dioxide (CO2), or which at a pressure of 1 atm and at temperatures between 1° and 70° C. has a solubility in water of from 0.5 to 2.5 g per kg of water, be transferred to a system for desorbing or desorption of the CO2 dissolved in said water stream (W4) thereby generating a stream of concentrated and purified CO2, and a third stream of water (W5), which third stream of water (W5) may be recirculated to the flow of said first water stream (W2) at a point, which is prior to said first water stream (W2) being contacted with said gas mixture (G1).

Further alternatively, the water stream (W4) may, if said first water stream (W2) is in the form of sea water, be collected and stored for subsequent use, e.g. for transport of the captured CO2 for utilization or for transfer of the captured CO2 to permanent or intermediate storage.

If the water stream (W2) used in a method or system according to the present invention is sourced e.g. from a geological storage formation, it may, furthermore, be used as a source of thermal energy to power the first part of the DAC process before being diverted to the methods and systems of the present invention. In such embodiments the overall need for external energy input for a DAC process in combination with the methods of the present invention will be lower than the sum of external energy input needed for the DAC and the methods of the present invention, when each viewed in isolation.

Also, the methods and systems of the present invention do, as compared to traditional processes relying on DAC, not rely on e.g., the addition of chemicals, just like they leave the relatively poorly soluble O2, N2 and Ar gases in the pressurized gas (G3), which has been depleted of substantially all of the CO2 compared to said flow of said first gas mixture (G1), which can then be vented from the system.

The CO2 is captured by contacting the entire gas stream (G1) with a water stream (W2). As the solubility of the different gases in the gas stream (G1) varies considerably, this will, however, in many situations require large amounts of water. For example at 293 K (app 20 C) and 1 atmosphere (app 1 bar) the solubility of the relatively soluble CO2 is 0.169 g per 100 g of water, whereas that of the relatively poorly soluble N2, 02 and Ar is only 0.0019, 0.0043 and 0.0062 g per 100 g of water, respectively. Hence, in the methods and systems of the present invention the flow of water (W2), when measured in kg/s, is typically at least 10 times to 135 times the flow of said stream of said first pressurized gas mixture (G1), when measured in kg/s.

Taking into account the variability of gas solubility, the methods and systems of the present invention ensures that substantially all of the CO2 can be separated from the other gases in the first gas stream (G1) by absorbing it into a first water stream (W2) thereby producing a second stream of water (W4) enriched with dissolved CO2 comparable to said first water stream (W2), and a second stream of pressurized gas (G3), which has been depleted of substantially all of the CO2 compared to said flow of said first gas mixture (G1).

In a preferred embodiment of the present invention the first water stream (W2) is in the form of groundwater from a geological reservoir, and the second water stream (W4), enriched with dissolved CO2 compared to said first water stream (W2), is transferred to an injection system for injecting said second water stream (W4) into the same geological reservoir for mineral storage of CO2. In a particularly preferred embodiment of such methods and systems, they will rely solely on resources in the form of electricity and water supplied either from the storage formation itself or as condensate from air originated from the DAC producing the first gas stream (G1).

Thus, combining DAC technologies with the abovementioned preferred and particularly preferred embodiments of the present invention reduces the overall resource demand of a process for permanently removing CO2 from atmospheric air and transforming it into solid carbonate minerals thus making it more favorable solution to be applied in the fight against climate change.

In another embodiment of methods and systems according to the present invention, the water stream (W4) produced may, if said gas mixture (G1) comprises less than 10%, such as less than 8, 6 or 4%, by volume of any gas or gases, which at the pressures and temperatures applied has or have a solubility in water, which is either equal to or higher than that of carbon dioxide (CO2), or which at a pressure of 1 atm and at temperatures between 1° and 70° C. has a solubility in water of from 0.5 to 2.5 g per kg of water, be transferred to a system for desorbing or desorption of the CO2 dissolved in said water stream (W4) thereby generating a stream of concentrated and purified CO2, and a third stream of water (W5), which third stream of water (W5) may be recirculated to the flow of said first water stream (W2) at a point, which is prior to said first water stream (W2) being contacted with said gas mixture (G1).

In yet another embodiment of methods and systems according to the present invention, in which said first water stream (W2) is in the form of sea water, the water stream (W4) may be collected and stored for subsequent use, e.g. for transport of the captured CO2 for utilization or for transfer of the captured CO2 to permanent or intermediate storage.

### SUMMARY OF THE INVENTION

Liquid and supercritical CO2 are routinely stored and transported commercially, and their compositional integrity can be assured. Efficient transportation of CO2 is possible given its low viscosity, high density and low critical temperature (31° C.) and pressure (74 bar). However, the liquefaction of CO2 as a purification step is, alongside the possible need for the removal of moisture from the CO2 enriched gas mixture produced by the DAC process prior to liquefaction, an energy intensive process(es) which may, in addition to the energy requirement of the DAC process itself, lead to a slowing down of the scaling up of such solutions as methods to mitigate climate change. In response to these challenges the methods and systems of the present invention enable an efficient direct air capture and storage/utilization chain by avoiding the liquefaction step and any possible need for the removal of moisture.

In addition, the simplicity of the methods and systems of the present invention relative to the known processes for separation of CO2 from CO2 containing gas mixtures, e.g. gas mixtures obtained by DAC, leads to both a decrease in relation to equipment requirements, which in turn lowers both the necessary capital costs and operating expenses of methods and systems according to the present invention compared to those of the prior art.

In preferred embodiments of the present invention, the methods and system may be optimized to provide storage pathways for CO2 that focuses on reactive rock formations, mine tailings, and highly alkaline industrial slag, respectively.

To address one or more of the above concerns, in a first aspect of the present invention a method is provided for separating substantially all of the CO2 from the additional constituents of a first gas mixture (G1), comprising:
at least 70% and up to 90% carbon dioxide (CO2) by volume,
   said method comprising the steps of:
   pressurizing said first gas mixture (G1) to a pressure of between 10 and 50 bar,
   contacting a stream of said pressurized first gas mixture (G1) with a first stream of water (W2), the pressure of which is between 10 and 50 bar, and the flow of which, when measured in kg/s, is 10 to 135 times the flow of said stream of said first pressurized gas mixture (G1), when measured in kg/s,
absorption of substantially all of said CO2 from said flow of said first pressurized gas mixture (G1) into said first stream of water (W2), thereby
producing:
a second stream of water (W4) enriched with dissolved CO2 comparable to said first water stream (W2), and
a second stream of pressurized gas (G3), which has been depleted of substantially all of the CO2 compared to said flow of said first gas mixture (G1)

In preferred embodiments the first gas mixture (G1) will comprise at least 80% and up to 90% CO2 by volume and have water contents above 500 ppm and/or a relative humidity of from 20 to 100% (i.e. it can be saturated with H2O).

In a preferred embodiment of a method according to the above-mentioned first aspect of the present invention said first gas mixture (G1) is pressurized to a pressure of between 20 and 40 bar, said first water stream (W2) is in the form of groundwater from a geological reservoir, and said method further comprises the step of:
transferring said second water stream (W4), enriched with dissolved CO2 compared to said first water stream (W2), to an injection system for injecting said second water stream (W4) into said geological reservoir for mineral storage of CO2.

In another preferred embodiment of a method according to the above-mentioned first aspect of the present invention said first gas mixture (G1) is pressurized to a pressure of between 20 and 40 bar, said first gas mixture (G1) comprises less than a total of 10%, such than less than 8, 6 or 4%, by volume of any gas or gases, which at the pressures and temperatures applied has or have a solubility in water, which is either equal to or higher than that of carbon dioxide (CO2), or which at a pressure of 1 atm and at temperatures between 1° and 70° C. has a solubility in water of from 0.5 to 2.5 g per kg of water, and said method further comprises the steps of:
transferring said second water stream (W4) enriched with dissolved CO2 compared to said first water stream (W2) to a system for desorbing or desorption of the CO2 dissolved in said second water stream (W4), thereby
generating:
a stream of CO2, and
a third stream of water (W5), which has been depleted of dissolved CO2 compared to said second water stream (W4).
recirculating said third stream of water (W5) to the flow of said first water stream (W2) at a point, which is prior to said first water stream (W2) being contacted with said stream of said pressurized first gas mixture (G1).

In another preferred embodiment of a method according to the above-mentioned first aspect of the present invention said first gas mixture (G1) is pressurized to a pressure of between 10 and 20 bar, said first water stream (W2) is in the form of sea water, and wherein said method further comprises the steps of:
collecting said second water stream (W4) enriched with dissolved CO2 compared to said first water stream (W2) for subsequent transport or transfer to permanent or intermediate storage.

In particularly, preferred embodiments of methods according to the above-mentioned first aspect of the present invention said first gas mixture (G1) is received from a direct air capture unit (DAC) or a unit designed to capture and/or concentrate CO2 containing gas mixtures emitted from industrial plants or power plants. To the extent that said first gas mixture (G1) originates from Direct Air Capture (DAC) systems it will in preferably comprise at least 80% and up to 90% CO2 by volume and can have water contents above 500 ppm and/or a relative humidity of from 20 to 100% (i.e. it can be saturated with H2O).

In the context of the present invention the term separating is to be understood as any means of setting or keeping apart differing constituents of a mixture, e.g. any means to isolate or extract one constituent of a mixture from the additional constituents of that mixture. In the context of the present invention the term separating substantially all of the CO2 from the additional constituents of a first gas mixture (G1) is to be understood as isolating or extracting substantially all of the CO2 in a first gas mixture from the additional constituents of that gas mixture.

In the context of the present invention separating substantially all of the CO2 from the additional constituents of a first gas mixture (G1), is to be understood as separating at least 95%, such as at least 96%, such as at least 97%, i.e. such as preferably at least 98% and even more preferably at least 99% of the CO2 in a first gas mixture from the additional constituents of that gas mixture.

In the context of the present invention the term transferring is to be understood as any means of transferring a liquid, e.g. water, or a gas (e.g. a gas mixture) from one location to another, e.g. by pumping.

In the context of the present invention the terms recirculate, recirculated and recirculating is to be understood as any means of the act or process of circulating a stream of a liquid or gas in a given process flow again, or causing a stream of a liquid or gas to be circulated in a given process flow again, e.g. by transferring a liquid, e.g. water, or a gas (e.g. a gas mixture) from a downstream location of a given forward directed flow of that liquid or gas to an upstream location of the same forward directed flow of said liquid or gas, e.g. by pumping.

In the context of the present invention the term stream is to be understood as a substance, e.g. water or gas, moving in a given direction at a given velocity at a certain flow rate, which may be provided as either a volumetric flow rate or a mass flow rate. Volumetric flow rate is the volume of fluid or gas which passes a given point per unit time and is usually represented by the symbol Q (sometimes V). The SI unit for volumetric flow rate is m3/s. Thus, Volume flow rate equals Volume/time. Mass flow rate on the other hand is the mass of fluid or gas which passes a given point per unit time. The SI unit for mass flow rate is kg/s.

In the context of the present invention the term water source or water is to be understood as any kind of water, such as e.g. water condensed from air, groundwater, ocean/sea-water, spring water, geothermal condensate or brine (geothermal water), or surface waters from rivers, streams or lakes.

In the context of the present invention the term injection well is to be understood as any kind of structure providing for a possibility of placing fluids or gases either deep underground or just into the ground in a downwardly direction, such as e.g. a device that places fluid into rock formations, such as basalt or basaltic rock, and porous rock formations, such as sandstone or limestone, or into or below the shallow soil layer.

In the context of the present invention a CO2 containing gas mixture is to be understood as any gas mixture of which the relative content of CO2 is higher than the relative content of CO2 of atmospheric air. In particularly preferred embodiments of the present invention CO2 containing gas mixtures comprise at least 70% and up to 90% carbon dioxide (CO2) by volume, such as at least 75% and up to 90% carbon dioxide (CO2) by volume, such as at least 80% and up to 90% carbon dioxide (CO2) by volume, such as at least 85% and up to 90% carbon dioxide (CO2) by volume. In particularly preferred embodiments of the present invention CO2 containing gas mixtures have water contents above 500 ppm and/or a relative humidity of from 20 to 100% (i.e. it will be partly or fully saturated with H2O), such as at least 0.05% of H2O by volume, such as at least 0.1% of H2O by volume, such as at least 0.15% of H2O by volume, such as at least 0.20% of H2O by volume, such as at least 0.25% of H2O by volume, such as at least 0.5% of H2O by volume, such as at least 0.75% of H2O by volume, such as at least 1% of H2O by volume, such as at least 1.25% of H2O by volume. Preferably CO2 containing gas mixtures according to the present invention comprise at least 80% and up to 90% CO2 by volume and have water contents above 500 ppm, i.e. at least 0.05% of H2O by volume.

In the context of the present invention the term hydraulic pressure is to be understood as the pressure of a hydraulic fluid which it exerts in all directions of a vessel, well, hose or anything in which it is present. A hydraulic pressure may give rise to flow in a hydraulic system as fluid flows from high pressure to low pressure.

Pressure is measured in the SI unit pascal (Pa), i.e. one newton per square meter (1 N/m2) or 1 kg/(m·s2), or 1 J/m3. Other units of pressure commonly used are pound per square inch or, more accurately, pound-force per square inch (abbreviation: psi) and bar. In SI units, 1 psi is approximately equal to 6895 Pa and 1 bar is equal to 100,000 Pa.

In the context of the present invention the term partial pressure or just pressure of a gas (of the CO2) is to be understood as the notional pressure of said given gas in a mixture of gases if this given gas in itself occupied the entire volume of the original mixture at the same temperature. The total pressure of an ideal gas mixture is the sum of the partial pressures of the individual constituent gases in the mixture.

In the context of the present invention the terms pressurize and pressurized is to be understood as the process of bringing to and maintaining, respectively, a pressure higher than that of the surroundings, e.g. higher than atmospheric pressure, such as between 15 and 45 bar, such as between 16 and 44 bar, such as between 17 and 43 bar, such as between 18 and 42 bar, such as between 19 and 41 bar, e.g. 20 to 40 bar. Notably, the terms pressurize and pressurized are in the context of the present invention not to be construed as meaning compressing a given gas or a given gas mixture into its liquid state, which would at a given temperature for a given gas or a given gas mixture imply subjecting it to a pressure above a certain threshold value.

In the context of the present invention the term contacting, e.g. contacting a stream of gas with a stream of water, is to be understood as bringing something into contact with something else, i.e. to cause two or more things to touch, physically interact or associate with one another.

In the context of the present invention the term absorption, e.g. absorption of a gas into water, is to be understood as a physical or chemical phenomenon or process in which atoms, molecules or ions enter a bulk phase, e.g. liquid or solid material. One example of this would be gas-liquid absorption, (also known as scrubbing), which is an operation in which a gas mixture is contacted with a liquid for the purpose of preferentially dissolving one or more components of the gas mixture and to provide a solution of them in the liquid. In principle there are 2 types of absorption processes: physical absorption and chemical absorption, depending on whether there is any chemical reaction between the solute and the solvent (absorbent). In processes like the ones of the present invention, where water is used as absorbent, chemical reactions only rarely occur between the absorbent and the solute, and the process is, thus, commonly referred to as physical absorption. However, in processes where the pH of the water absorbent has been modified by adding a base or an acid, absorption in water may, depending on the chemical nature of the solute, be accompanied by a rapid and irreversible neutralization reaction in the liquid phase and the process may then be referred to as chemical absorption or reactive absorption. Thus, chemical reactions caused e.g. by pH modification can be used to increase the rate of absorption, increase the absorption capacity of the solvent, increase selectivity to preferentially dissolve only certain components of a gas mixture, and/or convert a hazardous component of a gas mixture to a safe or safer compound.

In the context of the present invention the term producing, e.g. producing a stream of water or stream of pressurized gas, is to be understood as giving rise to, cause, create, bring forth, or yield something, e.g. a stream of water or a stream of pressurized gas.

In the context of the present invention, injecting/reinjecting or inject/reinject is to be understood as introducing/reintroducing something forcefully into something else, e.g. to force a fluid into an underground structure.

In the context of the present invention the term geological reservoir is to be understood as fractures in an underground structure, e.g. basaltic rock, that expands in other directions than upwardly and downwardly, which structure provides a flow path for the water injected into an injection well according to the present invention and may include what is referred to as a geothermal reservoir. In the present context the term geothermal reservoir is to be understood as fractures in hot rock that expand in other directions than upwardly and downwardly and provide a flowing path for the injected water from a well.

Accordingly, a method is provided that separates substantially all of the CO2 from the remaining gases of a first gas mixture (G1) by contacting it with a first water stream (W2) thereby producing a stream of water (W4) enriched with dissolved CO2 and thus prepares this gas for later storage, disposal or use.

In one embodiment the disposal may e.g. be based on injecting the stream of water (W4) enriched with dissolved CO2 into a geological system or reservoir where it forms chemical bindings via water-rock reactions. Thus, water-rock reactions that are already taking place in natural geological systems may be utilized by means of injecting the stream of water (W4) enriched with dissolved CO2 into the geological system or reservoir. Separating the CO2 by dissolving it in a water stream and injecting it into the subsurface to be considered as an ideal method for reducing CO2 concentrations in the atmosphere. In a particular preferred embodiment of such an embodiment involving disposal of the CO2, said first water stream (W2) may be in the form of groundwater from the same geological system or reservoir.

In one embodiment, said CO2 containing gas mixture (G1) further comprises at least one of following gases: O2, N2 and/or Ar, and said method of separating substantially all of the CO2 gas from the remaining gases contained in the CO2 containing gas mixture (G1) includes conducting the CO2 containing gas mixture (G1) containing at least also one of said O2, N2 and/or Ar gases through an absorption column where the CO2 is brought into contact with a stream of water (W2), so as to separate the dissolved CO2 from the remaining poorly soluble O2, N2, and/or Ar gases. In that way, a simple way is provided for separating the CO2 from said remaining poorly soluble gases, which remain in a second stream of pressurized gas (G3), which has been depleted of substantially all of the CO2 compared to said flow of said first gas mixture (G1).

In one embodiment, the said remaining gases, in said second stream of pressurized gas (G3), exiting the said absorption column is transferred to a system where energy is recovered by expanding the gases thus converting kinetic energy to useful energy with the aim of increasing overall system efficiency.

In one embodiment, the said remaining gases, in said second stream of pressurized gas (G3), exiting the said absorption column are diverted towards the inlet of the DAC following expansion to ambient pressure with the aim of increasing overall system efficiency. This solution is applied if the concentration of CO2 in said remaining gas mixture exiting the said absorption column is significantly higher than that of air.

In one embodiment, the stream of water enriched with dissolved CO2 (W4) is diverted to an evaporator where CO2 is exsolved from the water by releasing the pressure thus producing a stream of CO2 suitable for utilization and a third stream of water (W5), which has been depleted of dissolved CO2 compared to (W4). The resulting stream of water (W5) is then recirculated to the flow of said first water stream (W2) at a point, which is prior to said first water stream (W2) being contacted with said stream of said pressurized first gas mixture (G1), with the aim of being reused in the absorption column.

In a second aspect of the present invention a system is provided system for separating substantially all of the CO2 from the additional constituents of a first gas mixture (G1) comprising:
at least 70% and up to 90% carbon dioxide (CO2) by volume, said system comprising the following:
means for pressurizing said first gas mixture (G1) to a pressure of between 10 and 50 bar,
means for contacting a stream of said pressurized first gas mixture (G1) with a first stream of water (W2), the pressure of which is between 10 and 50 bar, and the flow of which, when measured in kg/s, is 10 to 135 times the flow of said stream of said first pressurized gas mixture (G1), when measured in kg/s, and
means for absorption of substantially all of said CO2 from said flow of said first pressurized gas mixture (G1) into said first stream of water (W2), and producing:
a second stream of water (W4) enriched with dissolved CO2 comparable to said first water stream (W2), and
a second stream of pressurized gas (G3), which has been depleted of substantially all of the CO2 compared to said flow of said first gas mixture (G1)

In preferred embodiments the first gas mixture (G1) will comprise at least 80% CO2 by volume and have water contents above 500 ppm, i.e. at least 0.05% of H2O by volume.

In a preferred embodiment of a system according to the above-mentioned second aspect of the present invention said means for:
contacting a stream of said pressurized first gas mixture (G1) with a first stream of water (W2), the pressure of which is at between 10 and 50 bar, and the flow of which, when measured in kg/s, is 10 to 135 times the flow of said stream of said first pressurized gas mixture (G1), when measured in kg/s, and
for absorption of substantially all of said CO2 from said flow of said first pressurized gas mixture (G1) into said first stream of water (W2), and producing:
a second stream of water (W4) enriched with dissolved CO2 comparable to said first water stream (W2), and
a second stream of pressurized gas (G3), which has been depleted of substantially all of the CO2 compared to said flow of said first gas mixture (G1), are an absorption column.

In another particularly preferred embodiment of a system according to the abovementioned second aspect of the present invention, said system further comprises means for:
sourcing said first water stream (W2) in the form of groundwater from a geological reservoir, and
transferring said second water stream (W4), enriched with dissolved CO2 compared to said first water stream (W2), to an injection system for injecting said second water stream (W4) into said geological reservoir for mineral storage of the CO2.

In another particularly preferred embodiment of a system according to the abovementioned second aspect of the present invention, said system further comprises means for:
transferring said second water stream (W4) enriched with dissolved CO2 compared to said first water stream (W2) to a system for desorbing or desorption of the CO2 dissolved in said second water stream (W4), thereby generating a stream of CO2 and a third stream of water (W5), which has been depleted of dissolved CO2 comparable to said second water stream (W4), and
recirculating said third stream of water (W5) to the flow of said first water stream (W2) at a point which is prior to said first water stream (W2) being contacted with said stream of said pressurized first gas mixture (G1).

It should be noted that the term water can, according to the present invention, mean condensate from air, fresh water, water from geothermal wells, brine (geothermal water), sea water and the like. Said water source may, thus, be any type of water. Likewise, the CO2 containing gas mixture (G1) comprising at least 70% and up to 90% CO2 may originate from any source, such as conventional power plants, geothermal power plants, industrial production, gas separation stations or the like. Preferably, however, the CO2 containing gas mixture (G1) comprising at least 70% and up to 90% CO2 originates from a DAC process. To the extent that said first gas mixture (G1) originates from Direct Air Capture (DAC) systems it will preferably comprise at least 80% and up to 90% CO2 by volume and have water contents above 500 ppm, i.e. at least 0.05% of H2O by volume.

In general, the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Hereinafter a number of embodiments of the invention are described, by way of example only, with reference to the drawings, in which:

FIG. 1 shows a flowchart of a method according to the present invention of separating substantially all of the CO2 from the additional constituents of a first gas mixture (G1), comprising at least 70% and up to 90% CO2 by volume, where said CO2 containing gas mixture (G1) contains at least also one of O2, N2, and/or Ar gases, such as gas mixture from DAC. To the extent that the gas mixture (G1) originates from Direct Air Capture (DAC) systems it will comprise at least 80% and up to 90% CO2 by volume and have water contents above 500 ppm, i.e. at least 0.05% of H2O by volume.

FIG. 2 shows a system according to the present invention for separating substantially all of the CO2 from the additional constituents of a first gas mixture (G1), comprising at least 70% and up to 90% CO2 by volume, where said CO2 containing gas mixture (G1) contains at least also one of O2, N2, and/or Ar gases, such as gas mixture from DAC. To the extent that the gas mixture (G1) originates from Direct Air Capture (DAC) systems it will comprise at least 80% and up to 90% CO2 by volume and have water contents above 500 ppm, i.e. at least 0.05% of H2O by volume.

FIG. 3 shows an absorption column and an injection well in accordance with a system and a method according to the present invention.

FIG. 4 shows a method for separating CO2 from a first gas mixture (G1) comprising at least 70% and up to 90% of CO2 in accordance with the present invention by contacting it with a first water stream (W2) from a geological system or reservoir (in an absorption column at 20-40 bar) thereby producing a second stream of water (W4) enriched with dissolved CO2 comparable to said first water stream (W2), followed by re-injection of this second water stream (W4) into the same geological system or reservoir. To the extent that the gas mixture (G1) originates from Direct Air Capture (DAC) systems it will comprise at least 80% and up to 90% CO2 by volume and have water contents above 500 ppm, i.e. at least 0.05% of H2O by volume.

FIG. 5 shows a method for separating CO2 from a first gas mixture (G1) comprising at least 70% and up to 90% of CO2 in accordance with the present invention by contacting it with a first water stream (W2) from a geological system or reservoir (in an absorption column at 20-40 bar) thereby producing a second stream of water (W4) enriched with dissolved CO2 comparable to said first water stream (W2), and transferring the second water stream (W4) to a system for desorbing or desorption of the CO2 dissolved in said second water stream (W4), thereby generating a stream of CO2, and a third stream of water (W5), which has been depleted of dissolved CO2 compared to said second water stream (W4). In certain embodiments, the water stream (W5), which results from the disposal/storage or utilization of the CO2 in water steam (W4), may be reused as water stream (W2) being contacted with said stream of said pressurized first gas mixture (G1).

FIG. 6 shows a recommended relationship between water flow rate and water temperature for a feed gas stream comprising 80% CO2 in a method according to the present invention. This illustrates the fact that CO2 absorption in water is temperature dependent since CO2 is more soluble at lower temperatures than higher temperatures. The water flow shown includes a 1.3× design factor.

FIG. 7 shows the relationship between the water flow rate required for absorption of 98% of the CO2 (in a feed gas stream comprising 80% CO2) in a method according to the present invention and the absorber column operating pressure. The water flow shown includes a 1.3× design factor.

FIG. 8 shows the power/energy consumption (in kWh) needed to absorb 1 ton of CO2 in a water stream initially having a near ambient temperature (i.e. in the specific example 20° C.) in scenarios involving variable water flow rates at a constant elevated pressure (20 bar).

FIG. 9 shows the power/energy consumption (in kWh) needed to absorb 1 ton of CO2 in a water stream initially having a near ambient temperature (i.e. in the specific example 20° C.) in scenarios involving variable elevated pressures at constant water flow rate (254000 kg/hr corresponding to app. 70.56 kg/s).

### DESCRIPTION OF EMBODIMENTS

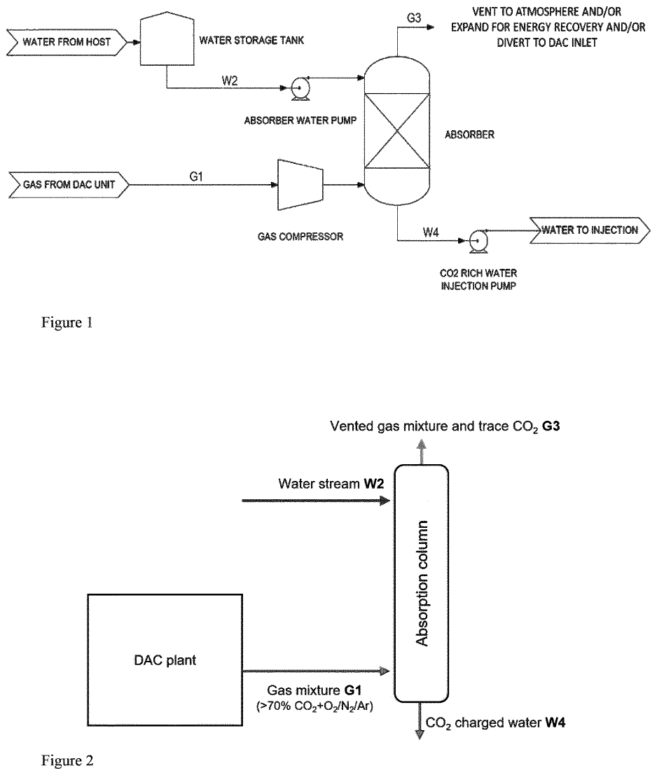

FIG. 1 shows a flowchart of a method according to the present invention of separating substantially all of the carbon dioxide (CO2) from the additional constituents of a CO2 containing gas mixture (G1) comprising at least 70% and up to 90% CO2 by volume and containing at least also one of O2, N2, Ar gases, such as gas stream from a DAC. To the extent that the gas mixture (G1) originates from Direct Air Capture (DAC) systems it will comprise at least 80% and up to 90% CO2 by volume and have water contents above 500 ppm, i.e. at least 0.05% of H2O by volume.

It should be noted that the CO2 containing gas mixture (G1) comprising at least 70% and up to 90% CO2 should in the context of the present invention not be construed as being limited to a gas stream from DAC. However, for simplicity, the following will refer to embodiments in which the CO2 containing gas mixture (G1) originates from DAC, and, hence, embodiments where the gas stream may further contain, but is not limited to, one or more gases selected from O2, N2 and Ar. The skilled person will, however, easily be able to modify the specific conditions described for the embodiments below, to provide specific conditions applicable to other embodiments, e.g. ones in which the CO2 containing gas mixture (G1) comprising at least 70% and up to 90% CO2, does not originate from DAC. To the extent that the gas mixture (G1) originates from Direct Air Capture (DAC) systems it will comprise at least 80% and up to 90% CO2 by volume and have water contents above 500 ppm, i.e. at least 0.05% of H2O by volume.

As will be discussed in more details in relation to FIG. 2, the separation of substantially all of the CO2, in the CO2 containing gas mixture (G1) comprising at least 70% and up to 90% CO2, from e.g. any O2, N2, and Ar contained in the gas stream (G1), is preferably performed by conducting the gas stream through an absorption column where substantially all of the CO2 becomes dissolved in a liquid, typically a water stream (W2), and in that way separated from the remaining more poorly-soluble O2, N2, and Ar gases. Subsequently, the resulting water stream (W4) comprising dissolved CO2 may be conducted to e.g. an injection well for disposal/storage or into another process for utilization of the CO2. In certain embodiments, the water stream (W5), which results from the disposal/storage or utilization of the CO2 in water steam (W4), may be reused as water stream (W2).

Referring to FIG. 2 the present invention in particular relates to a method and system for separating substantially all of the CO2 from the additional constituents of a first gas mixture (G1), comprising:
at least 70% and up to 90% carbon dioxide (CO2) by volume, said method comprising the steps of:
pressurizing said first gas mixture (G1) to a pressure of between 10 and 50 bar,
contacting a stream of said pressurized first gas mixture (G1) with a first stream of water (W2), the pressure of which is between 10 and 50 bar, and the flow of which, when measured in kg/s, is 10 to 135 times the flow of said stream of said first pressurized gas mixture (G1), when measured in kg/s,
absorption of substantially all of said CO2 from said flow of said first pressurized gas mixture (G1) into said first stream of water (W2), thereby
producing:
a second stream of water (W4) enriched with dissolved CO2 comparable to said first water stream (W2), and
a second stream of pressurized gas (G3), which has been depleted of substantially all of the CO2 compared to said flow of said first gas mixture (G1)

To the extent that the gas mixture (G1) originates from Direct Air Capture (DAC) systems it will comprise at least 80% and up to 90% CO2 by volume and have water contents above 500 ppm, i.e. at least 0.05% of H2O by volume.

As shown in FIG. 1, and as mentioned above, the second stream of pressurized gas (G3), exiting the absorption column may be transferred to a system where energy is recovered by expanding the gases thus converting kinetic energy to useful energy with the aim of increasing overall system efficiency, just like it may be diverted towards the inlet of the DAC following expansion to ambient pressure with the aim of increasing overall system efficiency if the concentration of CO2 in said remaining gas mixture exiting the said absorption column (G3) is significantly higher than that of air.

The steps of transferring said water stream (W4) enriched with dissolved CO2 either to an injection well for injecting said water stream (W4) into a geological reservoir, or to a system for utilization purposes are not shown in FIG. 2.

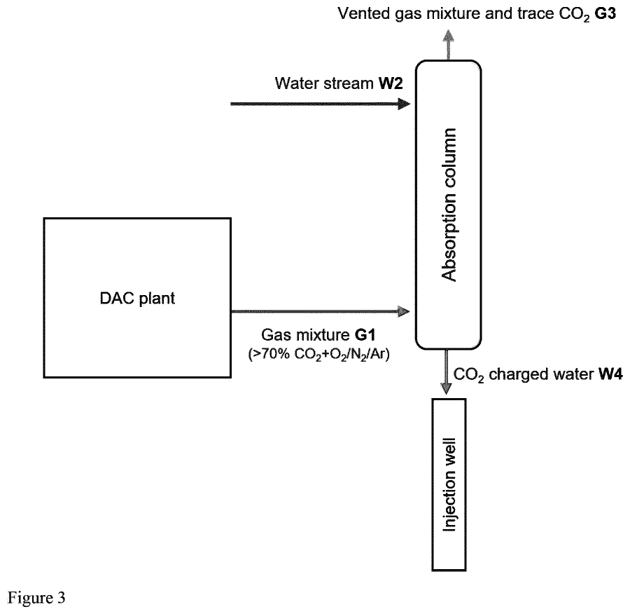

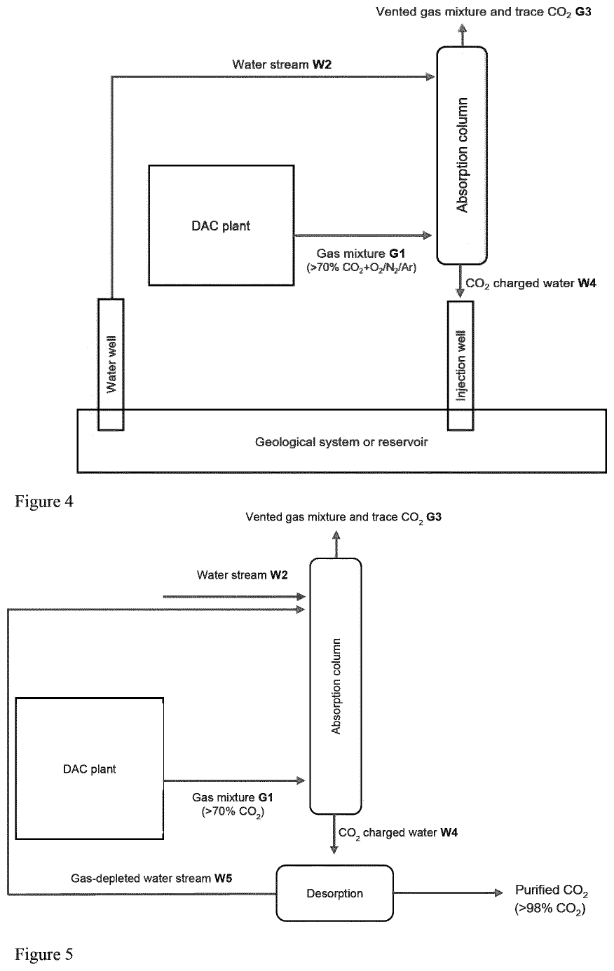

The step of transferring said water stream (W4) enriched with dissolved CO2 to an injection well for injecting said water stream (W4) into a geological reservoir is shown in FIG. 3.

The use of water stream (W4) for utilization purposes is shown in FIG. 5, where at least part of the water stream (W4) enriched with dissolved CO2 compared to said first water stream (W2) is transferred to a system for desorbing or desorption of the CO2 dissolved in said second water stream (W4), thereby generating a stream of CO2, and a third stream of water (W5), which has been depleted of dissolved CO2 compared to said second water stream (W4). In certain embodiments, the water stream (W5), which results from the disposal/storage or utilization of the CO2 in water steam (W4), may be reused as water stream (W2) being contacted with said stream of said pressurized first gas mixture (G1).

In a particularly preferred embodiment of a method according to the present invention the pressure of said pressurized gas mixture (G1) comprising at least 70% and up to 90% CO2 by volume and at least also one of H2, N2 and/or Ar, is between 15 and 45 bar, such as between 16 and 44 bar, such as between 17 and 43 bar, such as between 18 and 42 bar, such as between 19 and 41 bar, such as between 20 and 40 bar or between 15 and 40 bar, such as between 16 and 40 bar, such as between 17 and 40 bar, such as between 18 and 40 bar, such as between 19 and 40 bar or between 20 and 45 bar, such as between 20 and 44 bar, such as between 20 and 43 bar, such as between 20 and 42 bar, such as between 20 and 41 bar, i.e. such as above 15, 16, 17, 18, 19, 20, 21, 22, 23, 24 or 25 bar and below 40, 39, 38, 37, 36, 35, 34, 33, 32, 31 or 30 bar.

In a further particularly preferred embodiment of a method according to the present invention the temperature of said gas stream (G1) comprising at least 70% and up to 90% CO2 by volume is near to ambient, i.e. such as between 1° and 50° C., such as between 12 and 48° C., such as between 14 and 46° C., such as between 16 and 44° C., such as between 18 and 42° C., such as between 2° and 40° C., or such as between 15 and 50° C., such as between 16 and 50° C., such as between 17 and 50° C., such as between 18 and 50° C., such as between 19 and 50° C., such as between 20 and 50° C., or such as between 1° and 45° C., such as between 11 and 45° C., such as between 12 and 45° C., such as between 13 and 45° C., such as between 14 and 45° C., such as between 15 and 45° C., or such as between 15 and 21, 22, 23, 24, 25, 26, 27, 28, 29 or 30° C.

In a further particularly preferred embodiment of a method according to the present invention the temperature of said water stream (W2) is near to ambient, i.e. such as between 1° and 50° C., such as between 12 and 48° C., such as between 14 and 46° C., such as between 16 and 44° C., such as between 18 and 42° C., such as between 20 and 40° C., or such as between 15 and 50° C., such as between 16 and 50° C., such as between 17 and 50° C., such as between 18 and 50° C., such as between 19 and 50° C., such as between 20 and 50° C., or such as between 1° and 45° C., such as between 11 and 45° C., such as between 12 and 45° C., such as between 13 and 45° C., such as between 14 and 45° C., such as between 15 and 45° C., or such as between 15 and 21, 22, 23, 24, 25, 26, 27, 28, 29 or 30° C.

In a further particularly preferred embodiment of a method according to the present invention the pressure of said water stream (W2) is between 15 and 45 bar, such as between 16 and 44 bar, such as between 17 and 43 bar, such as between 18 and 42 bar, such as between 19 and 41 bar, such as between 20 and 40 bar or between 15 and 40 bar, such as between 16 and 40 bar, such as between 17 and 40 bar, such as between 18 and 40 bar, such as between 19 and 40 bar or between 20 and 45 bar, such as between 20 and 44 bar, such as between 20 and 43 bar, such as between 20 and 42 bar, such as between 20 and 41 bar, i.e. such as above 15, 16, 17, 18, 19, 20, 21, 22, 23, 24 or 25 bar and below 40, 39, 38, 37, 36, 35, 34, 33, 32, 31 or 30 bar. In a particularly preferred embodiment of a method according to the present invention the pressure of said water stream (W2) is app. 2 to 7 bar, such as 3 to 6 bar, such as 4 to 5 bar, above the pressure of said pressurized gas mixture (G1) comprising at least 70% and up to 90% CO2 by volume and at least also one of O2, N2, and/or Ar. Thus, if the pressure of said pressurized gas mixture (G1) comprising at least 70% and up to 90% CO2 by volume and at least also one of O2, N2, and/or Ar, is app. 20 bar the pressure of said water stream (W2) should preferably be app. 22 to 27 bar. Nonetheless, A skilled person will recognize that the optimal pressure difference between the pressures of said pressurized gas mixture (G1) comprising at least 70% and up to 90% CO2 by volume and at least also one of O2, N2, and/or Ar, and said water stream (W2) will depend on e.g. the column height of the applicable absorption column and the pressure drop in the applicable water distribution system, just like it will depend on where in a given system said pressures are measured.

In a further particularly preferred embodiment of a method according to the present invention the flow of said gas mixture (G1) is between 0.05 and 0.5 kg/s, such as between, kg/s 0.1 and 0.45 kg/s, such as between 0.15 and 0.4 kg/s, such as between 0.16 and 0.35 kg/s, such as between 0.17 and 0.3, such as between 0.18 and 0.25 kg/s, such as between 0.05, 0.06, 0.08, 0.1, 0.12 or 0.14 kg/s and 0.5, 0.4, 0.3 or 0.2 kg/s.

In a further particularly preferred embodiment of a method according to the present invention the flow of said water stream (W2) is between 5 and 15 kg/s, such as between 6 and 14 kg/s, such as between 7 and 13 kg/s, such as between 8 and 12 kg/s, such as between 5, 6, 7 or 8 kg/s and 15, 14, 13 or 12 kg/s.

In a further particularly preferred embodiment of a method according to the present invention the flow of said water stream (W2) is, when measured in kg/s, at least 10 to 135 times, such as at least 15 times, such as at least 20 times, such as at least 25 times, such as at least 30 times, such as at least 35 times, such as at least 40 times, such as at least 45 times the flow of said stream of said first pressurized gas mixture (G1), when measured in kg/s, i.e. such as at least 11 times, such as at least 12 times, such as at least 13 times, such as at least 14 times, such as at least 16 times, such as at least 17 times, such as at least 18 times, such as at least 19 times, such as at least 46, such as at least 47, such as at least 48, such as at least 49, such as at least 50, such as at least 51 to 135 times the flow of said stream of said first pressurized gas mixture (G1), when measured in kg/s.

In a further particularly preferred embodiment of a method according to the present invention the flow of said water stream (W2) is, when measured in kg/s, at least 10 to 135 times, such as at least 15 to 135 times, such as at least 20 to 135 times, such as at least 25 to 135 times, such as at least 30 to 135 times, such as at least 35 to 135 times, such as at least 40 to 135 times, such as at least 45 to 135 times the flow of said stream of said first pressurized gas mixture (G1), when measured in kg/s, i.e. such as at least 11 to 135 times, such as at least 12 to 134 times, such as at least 13 to 133 times, such as at least 14 to 132 times, such as at least 16 to 135 times, such as at least 17 to 134 times, such as at least 18 to 133 times, such as at least 19 to 132 times, such as least 46 to 134, such as least 47 to 133, such as least 48 to 132, such as least 49 to 131, such as least 50 to 130 times the flow of said stream of said first pressurized gas mixture (G1), when measured in kg/s.

In a further particularly preferred embodiment of a method according to the present invention said gas mixture (G1) comprising at least 70% and up to 90% CO2 by volume is a gas stream originating from a DAC. To the extent that the gas mixture (G1) originates from Direct Air Capture (DAC) systems it will comprise at least 80% and up to 90% CO2 by volume and have water contents above 500 ppm, i.e. at least 0.05% of H2O by volume.

Also, apart from the above-mentioned methods the present invention also in particular relates to a system for separating substantially all of the CO2 from the additional constituents of a first gas mixture (G1) comprising:
at least 70% and up to 90% carbon dioxide (CO2) by volume, said system comprising the following:
means for pressurizing said first gas mixture (G1) to a pressure of between 10 and 50 bar,
means for contacting a stream of said pressurized first gas mixture (G1) with a first stream of water (W2), the pressure of which is between 10 and 50 bar, and the flow of which, when measured in kg/s, is 10 to 135 times, such as at least 15 times, such as at least 20 times, such as at least 25 times, such as at least 30 times, such as at least 35 times, such as at least 40 times, such as at least 45 times the flow of said stream of said first pressurized gas mixture (G1), when measured in kg/s, i.e. such as at least 11 times, such as at least 12 times, such as at least 13 times, such as at least 14 times, such as at least 16 times, such as at least 17 times, such as at least 18 times, such as at least 19 times, such as at least 46, such as at least 47, such as at least 48, such as at least 49, such as at least 50, such as at least 51 to 135 times the flow of said stream of said first pressurized gas mixture (G1), when measured in kg/s, such as at least 10 to 135 times, such as at least 15 to 135 times, such as at least 20 to 135 times, such as at least 25 to 135 times, such as at least 30 to 135 times, such as at least 35 to 135 times, such as at least 40 to 135 times, such as at least 45 to 135 times the flow of said stream of said first pressurized gas mixture (G1), when measured in kg/s, i.e. such as at least 11 to 135 times, such as at least 12 to 134 times, such as at least 13 to 133 times, such as at least 14 to 132 times, such as at least 16 to 135 times, such as at least 17 to 134 times, such as at least 18 to 133 times, such as at least 19 to 132 times, such as least 46 to 134, such as least 47 to 133, such as least 48 to 132, such as least 49 to 131, such as least 50 to 130 times the flow of said stream of said first pressurized gas mixture (G1), when measured in kg/s, and
means for absorption of substantially all of said CO2 from said flow of said first pressurized gas mixture (G1) into said first stream of water (W2), and producing:
a second stream of water (W4) enriched with dissolved CO2 comparable to said first water stream (W2), and
a second stream of pressurized gas (G3), which has been depleted of substantially all of the CO2 compared to said flow of said first gas mixture (G1).

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

### EXAMPLES

### Example 1

A demonstration capture plant and injection system was designed for a DAC plant to be connected to a Carbfix injection facility at Hellisheiði in SW Iceland.

The gas stream from the DAC plant with 80% CO2 and 20% air (including any H2O) was directed to an absorption column, where CO2 was dissolved in water under elevated pressure (20 bar) at a constant temperature (15° C.-17° C.).

The operational conditions for capturing the water-soluble carbon dioxide (CO2) from the CO2 containing gas stream from DAC are outlined below:

### Operation

| | 1 | 2 | 3 | 4 |
|---|---|---|---|---|
| | Stream Name | | | |
| | Gas stream | | Gas from | |
| | from DAC | Water to | absorption | Water with |
| | plant | absorber | column | dissolved gases |
| Temp [° C.] | 30 | 15.3 | 15.4 | 17.1 |
| Pressure [bara] | 1 | 25 | 20 | 20 |
| Flow liquid | 0 | 9.5 | 0 | 9.66 |
| [kg/s] | | | | |
| Flow gas [kg/s] | 0.188 | 0 | 0.024 | 0 |

### Range:

| | 1 | 2 | 3 | 4 |
|---|---|---|---|---|
| | Stream name | | | |
| | Gas stream | | Gas from | |
| | from DAC | Water to | absorption | Water with |
| | plant | absorber | column | dissolved gases |
| Temp [° C.] | 39-41 | 15-20 | 15.2-20.2 | 15.5-20.5 |
| Pressure [bara] | 0.9-1.05 | 5-6 | 5-6 | 5-6 |
| Flow liquid | 0 | 36-56 | 0 | 50.2-55.4 |
| [kg/s] | | | | |
| Flow gas [kg/s] | 0.4-0.8 | 0 | 0.26 | 0 |

More than 95% of the carbon dioxide was dissolved in the water and injected deep into the bedrock at the plant site for mineralization.

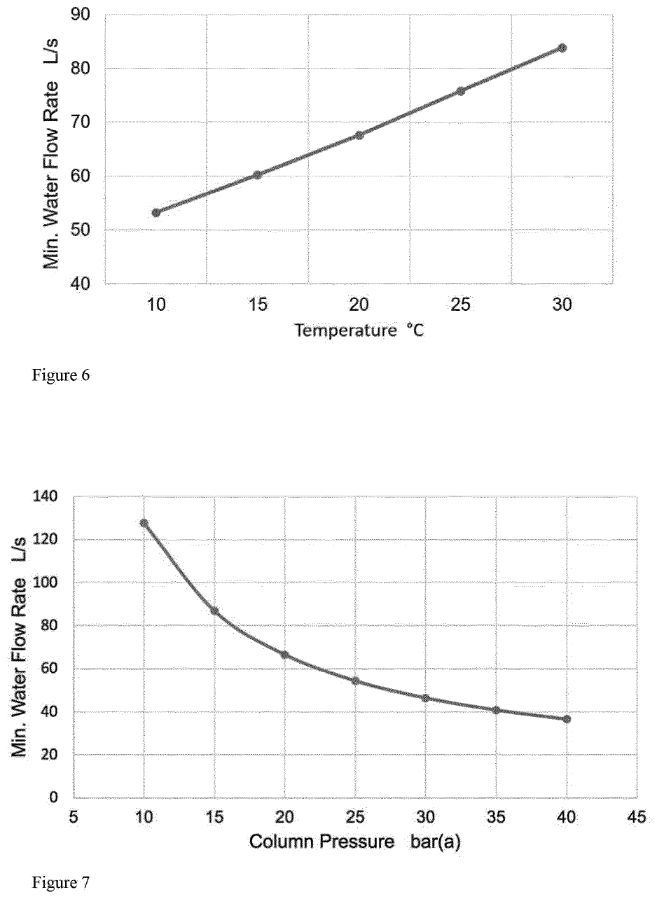

The skilled person will readily appreciate that the above-mentioned temperatures, flows and pressures are based on the specific conditions of a project in Hellisheiði in Iceland, and that given other pre-determined conditions as regards gas flow and temperature these might be different. Similarly, the skilled person will readily appreciate that the relevant water flow should be a certain ratio of the actual gas flow, which should be changed according to the applicable pressures and temperatures. In this context the skilled person would from e.g. the recommended relationship between water flow rate and water temperature for a feed gas stream comprising 80% CO2 in a method according to the present invention shown in FIG. 6, appreciate that CO2 absorption in water is temperature dependent since CO2 is more soluble at lower temperatures than higher temperatures. Likewise, the skilled person would be able to find the relationship between the water flow rate required for absorption of 98% of the CO2 (in a feed gas stream comprising 80% CO2) in a method according to the present invention and the absorber column operating pressure in FIG. 7.

### Example 2

A demonstration system to capture CO2 from a DAC plant and injecting the dissolved CO2 for mineral storage was designed.

The gas stream from the DAC plant contained 80% CO2 and 20% air and was directed to an absorption column under 20 bar using a dry compressor with a capacity of 832 kg/h. There, CO2 was dissolved in water under elevated pressure (20 bar) at a constant temperature (15° C.-17° C.).

Water was supplied by a submersible pump followed by a booster pump to the absorption column under 22 bar to compensate for pressure losses encountered in the system as well as the height difference between the pump where the water enters the column. The same water supply was used to cool a gas compressor feeding the absorption column. The spent cooling water was diverted to the stream of CO2 charged water exiting the absorption column resulting in elevated temperature of the water outlet relative to its inlet temperature.

For this system, water could also be passed by the absorption column directly to the injection well to ensure stable injection conditions in the event of unstable operating conditions of the absorption column. The maintenance of elevated pressure in the injection system prevents exsolution of any CO2 downstream of the absorption column and prevents sudden pressure and flow changes of the injection well during unstable gas supply.

The parameters of the stainless steel absorption column are shown below.

| Parameter | Value | |
|---|---|---|
| Tower Packing Details | Dump Packing Koch-Glitsch Beta Ring | |
| Theoretical Stages of Absorption | Six | |
| Assumed HETP | 1000 | mm |
| Total Packed Height | 6000 | mm |
| Sections of Packing | 2-3000 mm each | |
| Total Vessel Height (S/S) | 13.5 | m |
| Tower Packing Liquid Loading | 70 | m³/m²hr |
| Tower Diameter | 800 | mm |

The operational conditions for capturing the water-soluble carbon dioxide (CO2) from the CO2 containing gas stream from DAC using the parameters of the capture plant and to achieve above 98% CO2 capture efficiency are outlined below. The table shows that 51.3 kg of water are needed to capture 1 kg of CO2. This water carries the CO2 into the storage formation. Water is then withdrawn from the storage formation and supplied back to the system for re-use.

### Operation

| | 1 | 2 | 3 | 4 |
|---|---|---|---|---|
| | Stream Name | | | |
| | Gas stream | | Gas from | |
| | from DAC | Water to | absorption | Water with |
| | plant | absorber | column | dissolved gases |
| Temp [° C.] | 30 | 15.3 | 15.4 | 17.1 |
| Pressure [bara] | 1 | 22 | 20 | 20 |
| Flow [kg/s] | 0.188 | 9.5 | 0.024 | 9.66 |

### Range:

| | 1 | 2 | 3 | 4 |
|---|---|---|---|---|
| | Stream Name | | | |
| | Gas stream | | Gas from | |
| | from DAC | Water to | absorption | Water with |
| | plant | absorber | column | dissolved gases |
| Temp [° C.] | 39-41 | 15-20 | 15.5-20.4 | 16.1-21.1 |
| Pressure [bara] | 0.9-1.05 | 22-42 | 20-40 | 20-40 |
| Flow [kg/s] | 0.4-0.8 | 36-56 | 0.024 | 50.2-55.4 |

More than 98% of the carbon dioxide was dissolved in the water and injected deep into the bedrock at the plant site for mineralization (Patent PCT/EP 2020/064306)

The skilled person will readily appreciate that the above-mentioned temperatures, flows and pressures are based on the specific conditions of a specific DAC plant placed in a specific location where those utility streams are available, and that given other pre-determined conditions as regards gas flow and temperature these might be different. Similarly, the skilled person will readily appreciate that the relevant water flow should be a certain ratio of the actual gas flow, which should be changed according to the applicable pressures and temperatures. In this context the skilled person would from e.g. the recommended relationship between water flow rate and water temperature for a feed gas stream comprising 80% CO2 in a method according to the present invention shown in FIG. 6, appreciate that CO2 absorption in water is temperature dependent since CO2 is more soluble at lower temperatures than higher temperatures. Likewise, the skilled person would be able to find the relationship between the water flow rate required for absorption of 98% of the CO2 (in a feed gas stream comprising 80% CO2) in a method according to the present invention and the absorber column operating pressure in FIG. 7.

### Example 3

A demonstration system to capture CO2 from a DAC plant using seawater and injecting the dissolved CO2 into shallow underground formations for immediate solubility storage was designed.

The gas stream from the DAC plant contained 80% CO2 and 20% air and was directed to an absorption column under 10 bar pressure using liquid ring compressor with a capacity of 832 kg/h. There, CO2 was dissolved in water under elevated pressure (10 bar) at a constant temperature (15° C.).

Water was supplied by a submersible pump followed by a booster pump to the absorption column under 12 bar to compensate for pressure losses encountered in the system as well as the height difference between the pump where the water enters the column. The same water supply was used to cool a gas compressor feeding the absorption column. The spent cooling water was diverted to the stream of CO2 charged water exiting the absorption column (stream not shown on diagram) resulting in elevated temperature of the water outlet relative to its inlet temperature.

The same parameters of the stainless steel absorption column as in example 2 were used for this system.

The operational conditions for capturing the water-soluble carbon dioxide (CO2) from the CO2 containing gas stream from DAC using the parameters of the capture plant and to achieve above 98% CO2 capture efficiency are outlined below. The table shows that app. 100 to 130 kg of water are needed to capture 1 kg of CO2. This water carries the CO2 into the storage formation.

This system is designed to be operated in coastal or offshore regions. The seawater for the process can be supplied from shallow depths, in which case only electricity to achieve the operational pressure of the absorption column and to overcome the pressure losses in the system would be required. Furthermore, the gas charged water can be disposed of into shallow wells on the seabed at levels where hydrostatic pressure in the storage formation is above 10 bar (deeper than 102 m) to maintain the CO2 dissolved. The final arrangement of the injection well and the depth where the CO2 charged fluid exits the casing must consider the scale of injection activities and the reservoir structure and conditions. Parameters of the absorption column are shown below.

| Parameter | Value | |
|---|---|---|
| Tower Packing Details | Dump Packing Koch-Glitsch Beta Ring | |
| Theoretical Stages of Absorption | Six | |
| Assumed HETP | 1000 | mm |
| Total Packed Height | 6000 | mm |
| Sections of Packing | 2-3000 mm each | |
| Total Vesel Height (S/S) | 13.5 | m |
| Tower Packing Liquid Loading | 72 | m³/m²hr |
| Tower Diameter | 1000 | mm |

### Operational Parameters

| | 1 | 2 | 3 | 4 |
|---|---|---|---|---|
| | Stream Name | | | |
| | Gas stream | | Gas from | |
| | from DAC | Seawater to | absorption | Seawater with |
| | plant | absorber | column | dissolved gases |
| Temp [° C.] | 30 | 20 | 20 | 20.1 |
| Pressure [bara] | 1 | 12 | 10 | 10 |
| Flow [kg/s] | 0.188 | 17.2 | 0.024 | 17.2 |

As with the above examples, the skilled person will readily appreciate that the above-mentioned temperatures, flows and pressures are based on the specific conditions of this example, and that given other pre-determined conditions as regards gas flow and temperature these might be different. Similarly, the skilled person will readily appreciate that the relevant water flow should be a certain ratio of the actual gas flow, which should be changed according to the applicable pressures and temperatures. In this context the skilled person would from e.g. the recommended relationship between water flow rate and water temperature for a feed gas stream comprising 80% CO2 in a method according to the present invention shown in FIG. 6, appreciate that CO2 absorption in water is temperature dependent since CO2 is more soluble at lower temperatures than higher temperatures. Likewise, the skilled person would be able to find the relationship between the water flow rate required for absorption of 98% of the CO2 (in a feed gas stream comprising 80% CO2) in a method according to the present invention and the absorber column operating pressure in FIG. 7.

### Example 4

A demonstration system to capture CO2 from a DAC plant and injecting the dissolved CO2 for mineral storage has been designed.

The gas stream from the DAC plant contains 80% CO2 and 20% air at a flow rate of 4749 kg CO2 per hour (corresponding to app. 1.32 kg/s) and is directed to an absorption column. App. 99.85% of the CO2 is then absorbed in a water stream having an initial temperature of 20° C. at:
either at variable water flow rates under a constant elevated pressure (20 bar), at temperatures in the absorption column ranging from 20° C. to 1° C., respectively,
or under variable elevated pressures at constant water flow rate (254000 kg/hr corresponding to app. 70.56 kg/s) at temperatures in the absorption column ranging from 20° C. to 1° C., respectively.

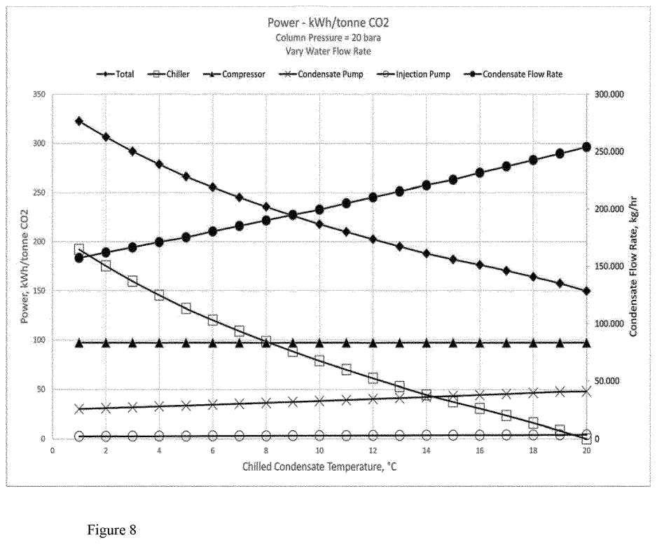

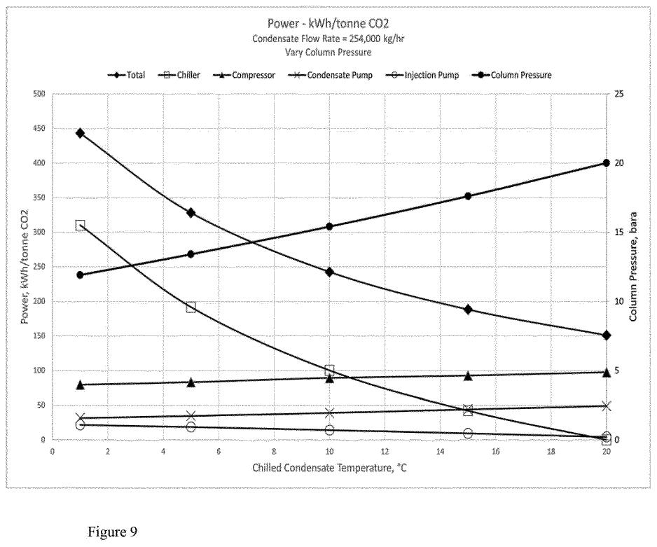

FIGS. 8 and 9 show the power/energy consumption (in kWh) needed to absorb 1 ton of CO2 under the various different process conditions. FIG. 8 relates to scenarios involving variable condensate/water flow rates (filled circle) at a constant elevated pressure (20 bar). FIG. 9 relates to scenarios involving variable elevated pressures (filled circle) at constant condensate/water flow rate (254000 kg/hr corresponding to app. 70.56 kg/s).

Both the individual energy consumption for any chilling (chiller) down of the water (open square), for the compressor (filled triangle), for the condensate/water pump (cross) and the injection pump (open circle), respectively, and the total (filled rhombus) power/energy consumption (in kWh) is shown in FIGS. 8 and 9 and the actual values are tabulated below. Operational parameters, constant condensate/water flow.

| | | |
|---|---|---|
| Absorber Pressure | bara | 20 |
| Injection Pump Pressure | bara | 22 |
| Condensate Pump Pressure | | 4 bar above column pressure |
| Condensate Supply Temperature | ° C. | 25 |
| NCG Temperature | ° C. | 25 |
| CO2 in Feed | kg/hr | 4.749 |
| CO2 Feed Composition | | 80% CO2 in air |
| CO2 Compressor Type | | dry screw compressor |
| CO2 Compressor Efficiency | % | 75 |
| Water Pump Efficiency | % | 75 |

| | | | | | | |
|---|---|---|---|---|---|---|
| Chilled Condensate | ° C. | 20 | 15 | 10 | 5 | 1 |
| Temperature | | | | | | |
| Column Pressure | bara | 20 | 17.6 | 15.4 | 13.4 | 11.9 |
| CO2 Captured | kg/hr | 4.742 | 4.742 | 4.742 | 4.742 | 4.742 |
| | % | 99.85% | 99.85% | 99.85% | 99.85% | 99.85% |
| Condensate Flow Rate | kg/hr | 253.961 | 253.402 | 253.295 | 253.793 | 253.786 |
| Condensate Chiller Duty | kWth | 0 | 1.486 | 2.973 | 4.473 | 5.664 |
| | tons refrig | 0 | 425 | 849 | 1278 | 1618 |
| Condensate Chiller Unit | kW/ton | 0.47 | 0.47 | 0.56 | 0.71 | 0.91 |
| Power | refrig | | | | | |

| | | | | | | |
|---|---|---|---|---|---|---|
| Condensate Chiller | kW | 0 | 199 | 474 | 908 | 1471 |
| Power | | | | | | |
| Compressor Power | kW | 462 | 439 | 423 | 394 | 377 |
| Condensate Pump Power | kW | 232 | 209 | 185 | 165 | 150 |
| Injection Pump Power | kW | 20 | 45 | 67 | 88 | 103 |
| Total Power | kW | 714 | 892 | 1150 | 1555 | 2101 |
| Condensate Chiller | kWh/tonne | 0 | 42 | 100 | 192 | 310 |
| Power | | | | | | |
| Compressor Power | kWh/tonne | 97 | 93 | 89 | 83 | 80 |
| Condensate Pump Power | kWh/tonne | 49 | 44 | 39 | 35 | 32 |
| Injection Pump Power | kWh/tonne | 4 | 9 | 14 | 19 | 22 |
| Total Power | kWh/tonne | 151 | 188 | 242 | 328 | 443 |

### Operational Parameters, Constant Pressure:

### Operational Parameters, Constant Pressure:

| | | | |
|---|---|---|---|
| Absorber Pressure | bara | 20 | |
| Injection Pump | bara | 22 | |
| Pressure | | | |
| Condensate Pump | bara | 4 bar above column | |
| Pressure | | pressure | |
| Condensate Supply | ° C. | 25 | |
| Temperature | | | |
| NCG Temperature | ° C. | 25 | |
| CO2 in Feed | kg/hr | 4.749 | |
| CO2 Feed | | 80% CO2 in air | |
| Composition | | | |
| CO2 Compressor | | dry screw compressor | |
| Type | | | |
| CO2 Compressor | % | 75 | avg, set to match |
| Efficiency | | | N&E budget quote |
| Water Pump | % | 75 | |
| Efficiency | | | |

| | | | | | | | | |
|---|---|---|---|---|---|---|---|---|
| Chilled Condensate | ° C. | 20 | 19 | 18 | 17 | 16 | 15 | 14 |
| Temperature | | | | | | | | |
| CO2 | kg/hr | 4.742 | 4.742 | 4.742 | 4.742 | 4.742 | 4.742 | 4.742 |
| Captured | | | | | | | | |
| | % | 99.85% | 99.85% | 99.85% | 99.85% | 99.85% | 99.85% | 99.85% |
| Condensate | kg/hr | 253.961 | 248.261 | 242.600 | 237.010 | 231.510 | 225.501 | 220.679 |
| Flow Rate | | | | | | | | |
| Condensate | kWth | 0 | 291 | 569 | 834 | 1.086 | 1.323 | 1.553 |
| Chiller Duty | | | | | | | | |
| | tons refrig | 0 | 83 | 163 | 238 | 310 | 378 | 444 |
| Condensate | kW/ton refrig | 0.47 | 0.47 | 0.47 | 0.47 | 0.47 | 0.47 | 0.48 |
| Chiller Unit | | | | | | | | |
| Power | | | | | | | | |
| Condensate | kW | 0 | 39 | 76 | 112 | 146 | 177 | 212 |
| Chiller | | | | | | | | |
| Power | | | | | | | | |
| Compressor | kW | 462 | 462 | 462 | 462 | 462 | 462 | 462 |
| Power | | | | | | | | |
| Condensate | kW | 228 | 226 | 221 | 216 | 211 | 206 | 201 |
| Pump Power | | | | | | | | |
| Injection | kW | 20 | 20 | 20 | 19 | 19 | 18 | 18 |
| Pump Power | | | | | | | | |
| Total Power | kW | 710 | 747 | 779 | 809 | 837 | 863 | 892 |
| Condensate | kWh/tonne | 0 | 8 | 16 | 24 | 31 | 37 | 45 |
| Chiller | | | | | | | | |
| Power | | | | | | | | |
| Compressor | kWh/tonne | 97 | 97 | 97 | 97 | 97 | 97 | 97 |
| Power | | | | | | | | |
| Condensate | kWh/tonne | 48 | 48 | 47 | 45 | 44 | 43 | 42 |
| Pump Power | | | | | | | | |
| Injection | kWh/tonne | 4 | 4 | 4 | 4 | 4 | 4 | 4 |
| Pump Power | | | | | | | | |
| Total Power | kWh/tonne | 150 | 158 | 164 | 171 | 177 | 182 | 188 |

| | | | | | | | | |
|---|---|---|---|---|---|---|---|---|
| Chilled Condensate | ° C. | 13 | 12 | 11 | 10 | 9 | 8 | 7 |
| Temperature | | | | | | | | |
| CO2 | kg/hr | 4.742 | 4.742 | 4.742 | 4.742 | 4.742 | 4.742 | 4.742 |
| Captured | | | | | | | | |
| | % | 99.85% | 99.85% | 99.85% | 99.85% | 99.85% | 99.85% | 99.85% |
| Condensate | kg/hr | 215.381 | 210.181 | 205.011 | 199.434 | 194.940 | 190.040 | 185.174 |
| Flow Rate | | | | | | | | |
| Condensate | kWth | 1.769 | 1.973 | 2.165 | 2.341 | 2.517 | 2.677 | 2.826 |
| Chiller Duty | | | | | | | | |
| | tons refrig | 505 | 564 | 619 | 669 | 719 | 765 | 807 |
| Condensate | kW/ton refrig | 0.49 | 0.51 | 0.54 | 0.56 | 0.58 | 0.61 | 0.64 |
| Chiller Unit | | | | | | | | |
| Power | | | | | | | | |
| Condensate | kW | 250 | 290 | 331 | 373 | 420 | 467 | 517 |
| Chiller | | | | | | | | |
| Power | | | | | | | | |
| Compressor | kW | 462 | 462 | 462 | 462 | 462 | 462 | 462 |
| Power | | | | | | | | |
| Condensate | kW | 196 | 191 | 186 | 182 | 177 | 173 | 168 |
| Pump Power | | | | | | | | |
| Injection | kW | 17 | 17 | 17 | 16 | 16 | 15 | 15 |
| Pump Power | | | | | | | | |
| Total Power | kW | 925 | 960 | 996 | 1033 | 1074 | 1117 | 1162 |
| Condensate | kWh/tonne | 53 | 61 | 70 | 79 | 88 | 99 | 109 |
| Chiller | | | | | | | | |
| Power | | | | | | | | |
| Compressor | kWh/tonne | 97 | 97 | 97 | 97 | 97 | 97 | 97 |
| Power | | | | | | | | |
| Condensate | kWh/tonne | 41 | 40 | 39 | 38 | 37 | 36 | 35 |
| Pump Power | | | | | | | | |
| Injection | kWh/tonne | 4 | 4 | 3 | 3 | 3 | 3 | 3 |
| Pump Power | | | | | | | | |
| Total Power | kWh/tonne | 195 | 202 | 210 | 218 | 227 | 236 | 245 |

| | | | | | | | |
|---|---|---|---|---|---|---|---|
| Chilled Condensate | ° C. | 6 | 5 | 4 | 3 | 2 | 1 |
| Temperature | | | | | | | |
| CO2 | kg/hr | 4.742 | 4.742 | 4.742 | 4.742 | 4.742 | 4.742 |
| Captured | | | | | | | |
| | % | 99.85% | 99.85% | 99.85% | 99.85% | 99.85% | 99.85% |
| Condensate | kg/hr | 180.405 | 175.242 | 171.112 | 166.559 | 162.097 | 157.274 |
| Flow Rate | | | | | | | |
| Condensate | kWth | 2.965 | 3.086 | 3.215 | 3.325 | 3.427 | 3.510 |
| Chiller Duty | | | | | | | |
| | tons refrig | 847 | 882 | 919 | 950 | 979 | 1003 |
| Condensate | kW/ton refrig | 0.67 | 0.71 | 0.75 | 0.80 | 0.85 | 0.91 |
| Chiller Unit | | | | | | | |
| Power | | | | | | | |
| Condensate | kW | 571 | 627 | 690 | 758 | 832 | 912 |
| Chiller | | | | | | | |
| Power | | | | | | | |
| Compressor | kW | 462 | 462 | 462 | 462 | 462 | 462 |
| Power | | | | | | | |
| Condensate | kW | 164 | 159 | 155 | 151 | 147 | 143 |
| Pump Power | | | | | | | |
| Injection | kW | 15 | 14 | 14 | 13 | 13 | 13 |
| Pump Power | | | | | | | |
| Total Power | kW | 1211 | 1262 | 1322 | 1384 | 1454 | 1529 |
| Condensate | kWh/tonne | 120 | 132 | 146 | 160 | 175 | 192 |
| Chiller | | | | | | | |
| Power | | | | | | | |
| Compressor | kWh/tonne | 97 | 97 | 97 | 97 | 97 | 97 |
| Power | | | | | | | |
| Condensate | kWh/tonne | 35 | 34 | 33 | 32 | 31 | 30 |
| Pump Power | | | | | | | |
| Injection | kWh/tonne | 3 | 3 | 3 | 3 | 3 | 3 |
| Pump Power | | | | | | | |
| Total Power | kWh/tonne | 255 | 266 | 279 | 292 | 307 | 323 |

As can be noted from the above tables and FIGS. 8 and 9, the power/energy consumption (in kWh) necessary for any chilling down of the water/condensate (chiller, open square) in both cases becomes significant (i.e. amounts to more than app. 33% of the total energy consumption, filled rhombus) if the water/condensate stream (originally being of ambient temperature) has to be cooled to a temperature below app. 10° C. Thus, these results show that there is a significant increase in the total power/energy consumption (in kWh) for any system based on the absorption of CO2 in a water/condensate stream of near to ambient temperature (i.e. in this case 20° C.), and, hence, a significant reduction in the efficiency with which CO2 can be absorbed, if the water/condensate temperature is to be lowered significantly below 10° C.

1. A method for separating at least 98% of the CO₂ from the additional constituents of a first gas mixture (G1) received from a direct air capture unit (DAC), wherein said first gas mixture (G1) is at a temperature between app. 10 and app. 50° C. and comprises:
from 70% to 90% carbon dioxide (CO2) by volume,
a water content above 500 ppm,
said method comprising the steps of:
pressurizing said first gas mixture (G1) to a pressure of between 15 and 45 bar,
contacting a stream of said pressurized first gas mixture (G1) with a first stream of water (W2), in the form of water condensed from air, groundwater, ocean/sea-water, spring water, geothermal condensate or brine (geothermal water), or surface waters from rivers, streams or lakes, the temperature of which is between app. 10 and app. 50° C., the pressure of which is between 15 and 45 bar, and the flow of which, when measured in kg/s, is from 10 to 135 times the flow of said stream of said first pressurized gas mixture (G1), when measured in kg/s,
absorption of at least 98% of said CO₂ from said flow of said first pressurized gas mixture (G1) into said first stream of water (W2), thereby
producing:
a second stream of water (W4) enriched with dissolved CO2 comparable to said first water stream (W2), and
a second stream of pressurized gas (G3), which has been depleted of at least 98% of the CO₂ compared to said flow of said first gas mixture (G1),
transferring at least part of said second water stream (W4), enriched with dissolved CO₂ compared to said first water stream (W2), to an injection system for injecting said second water stream (W4) into a geological reservoir for storage of CO₂
transferring said second stream of pressurized gas (G3):
for venting to the atmosphere,
to a system for expansion of said stream of gas, and/to
to the inlet of said DAC unit.

2. The method according to claim 1, wherein:
said first gas mixture (G1) is pressurized to a pressure of between 20 and 40 bar,
said first water stream (W2) is in the form of groundwater from a geological system or reservoir, and
wherein said method further comprises the step of transferring said second water stream (W4), enriched with dissolved CO₂ compared to said first water stream (W2), to an injection system for injecting said second water stream (W4) into the same geological system or reservoir for storage of CO₂.

3. The method according to claim 1, wherein:
said first gas mixture (G1) is pressurized to a pressure of between 20 and 40 bar,
said first gas mixture (G1) comprises less than a total of 10% by volume of any gas or gases, which at the pressures and temperatures applied has or have a solubility in water, which is either equal to or higher than that of CO₂, and
wherein said method further comprises the steps of:
transferring at least part of said second water stream (W4) enriched with dissolved CO₂ compared to said first water stream (W2) to a system for desorbing or desorption of the CO₂ dissolved in said second water stream (W4), thereby
generating:
a stream of CO₂, and
a third stream of water (W5), which has been depleted of dissolved CO₂ compared to said second water stream (W4), and
recirculating said third stream of water (W5) to the flow of said first water stream (W2) at a point, which is prior to said first water stream (W2) being contacted with said stream of said pressurized first gas mixture (G1).

4. The method according to claim 1, wherein said first water stream (W2) is in the form of sea water, and wherein said method further comprises the steps of:
collecting at least part of said second water stream (W4) enriched with dissolved CO₂ compared to said first water stream (W2) for subsequent transport or transfer to permanent or intermediate storage.

5. The method according to any of claim 1, wherein the temperature of said first gas mixture (G1) is between 10 and 50° C.

6. The method according to claim 1, wherein the temperature of said first water stream (W2) is between 10 and 50° C.

7. The method according to claim 1, wherein the flow of said first gas mixture (G1) is between 0.05 and 0.5 kg/s.

8. The method according to any claim 1, wherein the flow of said first water stream (W2) is between 1.5 and 15 kg/s.

9. (canceled)

10. A system for separating at least 98% of the CO₂ from the additional constituents of a first gas mixture (G1) which is received from a direct air capture unit (DAC), wherein said first gas mixture (G1) is at a temperature between app. 10 and app. 50° C. and comprises:
from 70% to 90% carbon dioxide (CO₂) by volume,
a water content above 500 ppm,
said system comprising the following:
means for pressurizing said first gas mixture (G1) to a pressure of between 15 and 45 bar,
means for sourcing a first water stream (W2), in the form of water condensed from air, groundwater, ocean/sea-water, spring water, geothermal condensate or brine (geothermal water), or surface waters from rivers, streams or lakes, the temperature of which is between app. 10 and app. 50° C., and
means for contacting a stream of said pressurized first gas mixture (G1) with said first stream of water (W2), the pressure of which is between 15 and 45 bar, and the flow of which, when measured in kg/s, is from 10 to 135 times the flow of said stream of said first pressurized gas mixture (G1), when measured in kg/s, and
means for absorption of at least 98% of said CO₂ from said flow of said first pressurized gas mixture (G1) into said first stream of water (W2), and producing:
a second stream of water (W4) enriched with dissolved CO₂ comparable to said first water stream (W2), and
a second stream of pressurized gas (G3), which has been depleted of at least 98% of the CO₂ compared to said flow of said first gas mixture (G1)
means for transferring at least part of said second water stream (W4), enriched with dissolved CO₂ compared to said first water stream (W2), to an injection system for injecting said second water stream (W4) into a geological reservoir for storage of the CO₂, and
means for transferrin aid second stream of pressurized gas (G3)
for venting to the atmosphere,
to a system for expansion of said stream of gas, and/or
to the inlet of said DAC unit.

11. The system according to claim 10 wherein said means for:
contacting a stream of said pressurized first gas mixture (G1) with said first stream of water (W2), and
for absorption of at least 98% of said CO₂ from said flow of said first pressurized gas mixture (G1) into said first stream of water (W2), and producing:
i. a second stream of water (W4) enriched with dissolved CO₂ comparable to said first water stream (W2), and
ii. a second stream of pressurized gas (G3), which has been depleted of at least 98% of the CO₂ compared to said flow of said first gas mixture (G1),
are an absorption column.

12. (canceled)

13. The system according to claim 10 further comprising means for:
transferring at least part of said second water stream (W4) enriched with dissolved CO₂ compared to said first water stream (W2) to a system for desorbing or desorption of the CO₂ dissolved in said second water stream (W4), thereby generating a stream of CO₂ and a third stream of water (W5), which has been depleted of dissolved CO₂ comparable to said second water stream (W4), and
recirculating said third stream of water (W5) to the flow of said first water stream (W2) at a point which is prior to said first water stream (W2) being contacted with said stream of said pressurized first gas mixture (G1).
